(19) United States
(12) Patent Application Publication
(10) Pub. No.: US 2016/0239591 A1
(43) Pub. Date: Aug. 18, 2016

(54) Method and System to Enhance Computations For A Physical System

(71) Applicant: Rahul S. SAMPATH, SPRING, TX (US)

(72) Inventor: Rahul S. SAMPATH, SPRING, TX (US)

(21) Appl. No.: 14/934,842

(22) Filed: Nov. 6, 2015

Related U.S. Application Data
(60) Provisional application No. 62/116,124, filed on Feb. 13, 2015.

(51) Int. Cl. G06F 17/50; G06F 17/10

(52) U.S. Cl. CPC G06F 17/5009; G06F 17/10

(57) ABSTRACT

A method and system for performing computations of physical systems are described. The method and system involve a hardware aware flexible layout for storing two dimensional (2-D) or three-dimensional (3-D) data in memory for stencil computations, which may be used for exploration, development and production of hydrocarbons. The stencil parameters are utilized to form macroblocks that lessen halo exchanges.

### CROSS-REFERENCE TO RELATED APPLICATION

This application claims the benefit of U.S. Provisional Patent Application 62/116,124 filed Feb. 13, 2015, entitled METHOD AND SYSTEM TO ENHANCE COMPUTATIONS FOR A PHYSICAL SYSTEM, the entirety of which is incorporated by reference herein.

### FIELD OF THE INVENTION

Embodiments of the present disclosure relate generally to the field of computations of physical systems. More particularly, the present disclosure relates to systems and methods for hardware aware flexible layout for storing two dimensional (2-D) or three-dimensional (3-D) data in memory for stencil computations, which may be used for exploration, development and production of hydrocarbons.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

Numerical simulation is widely used in industrial fields as a method of simulating a physical system. In most simulations, the objective is to model the transport processes occurring in the physical systems, which may include mass, energy, momentum, or some combination thereof. By using numerical simulation, a modeler attempts to reproduce and to observe a physical phenomenon. The simulation may be performed to model the physical system and to determine various parameters associated with the physical system. As an example, numerical simulations are utilized in the exploration, development and production of hydrocarbons, subsurface models (e.g., reservoir models and/or geologic models).

As part of these numerical simulations, various scientific computations are involved, which increase in complexity and the amount of data being processed. For example, in the exploration, development and production of hydrocarbons, subsurface models (e.g., reservoir models and/or geologic models) involve measured data that is processed to provide information about the subsurface. The amount of data that is processed continues to increase to provide a more complete understanding of the subsurface. That is, more data is utilized to provide additional information; to refine the understanding of subsurface structures and to model production from such structures.

The processing techniques may include one or more processing devices to lessen the time associated with processing of the data. That is, the processing of the data may include parallel processing and/or serial processing techniques. Parallel processing is the simultaneous execution of the different tasks on multiple processing devices to obtain results in less time, while serial processing is the execution of the different tasks in a sequence within a processing device. To provide enhancements in computational efficiency, parallel processing relies on dividing operations into smaller tasks, which may be performed simultaneously on different processing devices. For example, the processing may include processing devices, such as multicore/many core microprocessors, graphics processing units (GPUs) and high performance computing (HPC) systems to provide solutions in a practical amount of time. As may be appreciated, delays in processing a single task may delay the final solution and result.

Stencil computations (i.e. kernels) are an integral part of simulations of physical systems, which use finite difference method (FDM), finite volume method (FVM); or finite element method (FEM) on grids. For parallel implementations of stencil computations, data is exchanged between processing devices with the data being transferred referred to as halos.

The inefficiencies in stencil computations increase as the width of the stencils increase. For example, the performance bottlenecks that lessen operational efficiency may include exchanging more halos and/or performing memory accesses that are not cache optimal.

To address such problems, conventional techniques utilize various mechanisms. For example, one mechanism may include lexicographic data layout. Lexicographic data layout involves row or column major ordering. Another mechanism involves overlap communication and computation, which is in an attempt to hide parallel overhead. Further, loop tiling or cache blocking may be used to re-use cached data. Finally, re-ordering data is used to improve locality. One such technique is to use space filling curves. Yet, while the re-ordering data to improve locality may reduce the cache and translation look-up buffer (TLB) misses, it fails to lessen halo extraction and/or halos injection overhead. Indeed, conventional approaches of data re-ordering typically require storing an additional look-up table that stores the map for this re-ordering, which is additional overhead.

As such, there is a need for enhanced techniques that may effectively use two-dimensional (2-D) and/or three-dimensional (3-D) domain decomposition and store such data to avoid halo injection operations and the halo extraction operations in the slow-varying directions. Further, enhanced techniques are needed to provide macro-block decomposition to lessen halo extraction and/or injection overhead with data re-ordering to enhance locality. Also, enhanced techniques are needed to lessen look-up tables by having the mapping built into the standard 2-D and/or 3-D array data structure used for stencil computations.

### SUMMARY

According to disclosed aspects and methodologies, a system and method are provided for simulating a physical system with two or more processing devices. The method includes determining stencil parameters for data representing a physical system; allocating memory for at least one of a plurality of processing devices based at least partially on the stencil parameters, wherein the allocated memory is further divided into a plurality of macroblocks based on the stencil parameters; concurrently processing with the plurality of processing devices the data in a simulation of the physical system; outputting the simulation results; and performing operations on the physical system based on the simulation results.

In yet another embodiment, a computer system for simulating a physical system with two or more processing devices is described. The computer system includes a plurality of processing devices; memory in communication with at least one of the plurality of processing devices; and a set of instructions stored in memory and accessible by the processor. The set of instructions, when executed by the processor, are configured to: determine stencil parameters for data representing a physical system; allocate memory for at least one of the plurality of processing devices based at least partially on the stencil parameters, wherein the allocated memory is further divided into a plurality of macroblocks based on the stencil parameters; perform a simulation with the data and the plurality of processing devices, wherein the at least one of the plurality of processing devices relies upon the allocated memory to perform stencil computations for a portion of the data associated with the at least one of the plurality of processing devices; and output the simulation results.

Further, in one or more embodiments, the allocation of memory for the at least one of the plurality of processing devices further comprises: assigning one of the two or more sub-grids to the at least one of the plurality of processing devices; dividing the one of the two or more sub-grids into a plurality of regions; and dividing the plurality of regions into the plurality of macroblocks. The stencil parameters may be determined is based on equations used in the simulation.

### BRIEF DESCRIPTION OF THE DRAWINGS

The foregoing and other advantages of the present disclosure may become apparent upon reviewing the following detailed description and drawings of non-limiting examples of embodiments.

FIG. 1 is a flow diagram of a method for configuring data blocks in accordance with an exemplary embodiment of the present techniques.

FIG. 2 is a flow diagram of a method for simulating using stencil computations in accordance with an exemplary embodiment of the present techniques.

FIG. 3 is an exemplary a diagram of sub-grid and associated halos received from other sub-grids for a processing device.

FIG. 4 is a layout diagram of a 1D array in accordance with an exemplary embodiment of the present techniques.

FIG. 5 is a layout diagram of an exemplary group of macro-blocks that are decomposed from one of the three regions of Neg, Cen and Pos of FIG. 4 in accordance with an exemplary embodiment of the present techniques.

FIG. 6 is a layout diagram of the X dimension in the Cen region from the layout diagram of FIG. 5.

FIG. 7 is a block a diagram of a computer system in accordance with an exemplary embodiment of the present techniques.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the definition persons in the pertinent art have given that term in the context in which it is used.

As used herein, “a” or “an” entity refers to one or more of that entity. As such, the terms “a” (or “an”), “one or more”, and “at least one” can be used interchangeably herein unless a limit is specifically stated.

As used herein, the terms “comprising”, “comprises”, “comprise”, “comprised”, “containing”, “contains”, “contain”, “having”, “has”, “have”, “including”, “includes”, and “include” are open-ended transition terms used to transition from a subject recited before the term to one or more elements recited after the term, where the element or elements listed after the transition term are not necessarily the only elements that make up the subject.

As used herein, “exemplary” means exclusively “serving as an example, instance, or illustration”. Any embodiment described herein as exemplary is not to be construed as preferred or advantageous over other embodiments.

As used herein, “concurrently” means at the same time. As an example, two processing devices may perform computations concurrently if the processing devices are performing the operations at the same time. While the processing devices may start and complete the computations at different times, it is still considered to be concurrent because of the overlap in the operations occurring at the same time. That is, the concurrent operations include an overlap in performing the different operations on different devices.

As used herein, “computer-readable medium” or “tangible machine-readable medium” as used herein refers to any tangible storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, the invention is considered to include a tangible storage medium or tangible distribution medium and prior art-recognized equivalents and successor media, in which the software implementations of the present invention are stored.

As used herein, “displaying” includes a direct act that causes displaying, as well as any indirect act that facilitates displaying. Indirect acts include providing software to an end user, maintaining a website through which a user is enabled to affect a display, hyperlinking to such a website, or cooperating or partnering with an entity who performs such direct or indirect acts. Thus, a first party may operate alone or in cooperation with a third party vendor to enable the reference signal to be generated on a display device. The display device may include any device suitable for displaying the reference image, such as without limitation a CRT monitor, a LCD monitor, a plasma device, a flat panel device, virtual reality goggles, or a printer. The display device may include a device which has been calibrated through the use of any conventional software intended to be used in evaluating, correcting, and/or improving display results (for example, a color monitor that has been adjusted using monitor calibration software). Rather than (or in addition to) displaying the reference image on a display device, a method, consistent with the invention, may include providing a reference image to a subject. “Providing a reference image” may include creating or distributing the reference image to the subject by physical, telephonic, or electronic delivery, providing access over a network to the reference, or creating or distributing software to the subject configured to run on the subject's workstation or computer including the reference image. In one example, the providing of the reference image could involve enabling the subject to obtain the reference image in hard copy form via a printer. For example, information, software, and/or instructions could be transmitted (for example, electronically or physically via a data storage device or hard copy) and/or otherwise made available (for example, via a network) in order to facilitate the subject using a printer to print a hard copy form of reference image. In such an example, the printer may be a printer which has been calibrated through the use of any conventional software intended to be used in evaluating, correcting, and/or improving printing results (for example, a color printer that has been adjusted using color correction software).

As used herein, “flow simulation” or “reservoir simulation” is defined as a computer-implemented numerical method of simulating the transport of mass (typically fluids, such as oil, water and gas), energy, and momentum through a physical system. The physical system may include a three dimensional reservoir model, fluid properties, and the number and locations of wells. Flow simulations also require a strategy (often called a well-management strategy) for controlling injection and production rates. These strategies are typically used to maintain reservoir pressure by replacing produced fluids with injected fluids (for example, water and/or gas). When a flow simulation correctly recreates a past reservoir performance, it is said to be “history matched”, and a higher degree of confidence is placed in its ability to predict the future fluid behavior in the reservoir.

As used herein, “genetic algorithms” refer to a type of optimization algorithm that can be used for history matching. In this type of optimization algorithm, a population of input parameter sets is created, and each parameter set is used to calculate the objective function. In history matching, the objective function is calculated by running a flow simulation. A new population of parameter sets is created from the original population using a process analogous to natural selection. Members of the population that give a poor objective function value are eliminated, while parameter sets that give improvement in the objective function are kept, and combined in a manner similar to the way biological populations propagate. There are changes to parameter sets that are similar to inheritance, mutation, and recombination. This process of creating new populations continues until a match is obtained.

As used herein, “formation” means a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state, related to the geologic development of the subsurface region. A formation may contain numerous geologic strata of different ages, textures and mineralogic compositions. A formation can refer to a single set of related geologic strata of a specific rock type or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

As used herein, “hydrocarbon management” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

As used herein, “objective function” refers to a mathematical function that indicates the degree of agreement or disagreement (mismatch) between results of running a tentative reservoir model and the field measurements. In matching simulation results with the production history, an objective function is commonly defined so as to attain a zero value for perfect agreement and a higher positive value for less precise agreement. An example of a commonly used objective function is the sum of the squares in the error (simulation minus observed) for a given production measurement (pressure phase rate, etc.). A low value of the objective function indicates good agreement between simulation results and field measurements. The goal in history matching is to obtain the lowest possible value of the objective function.

As used herein, “optimization algorithms” refer to techniques for finding minimum or maximum values of an objective function in a parameter space. Although the techniques may be used with the intention of finding global minima or maxima, they may locate local minima or maxima instead of, or in addition to, the global minima or maxima. The techniques may use genetic algorithms, gradient algorithms, direct search algorithms, or stochastic optimization methods. These are described in the references on optimization at the beginning of the patent.

As used herein, “parameter subspace” refers to a part of the initial parameter space, defined using either a subset of the total number of parameters or a smaller range of possible values for the parameters or some combination thereof.

As used herein, “physics-based model” refers to a predictive model that receives initial data and predicts the behavior of a complex physical system such as a geologic system based on the interaction of known scientific principles on physical objects represented by the initial data. For example, these models may be used in reservoir simulations or geologic simulations.

As used herein, “reservoir” or “reservoir formations” are typically pay zones (for example, hydrocarbon producing zones) that include sandstone, limestone, chalk, coal and some types of shale. Pay zones can vary in thickness from less than one foot (0.3048 m) to hundreds of feet (hundreds of m). The permeability of the reservoir formation provides the potential for production.

As used herein, “reservoir properties” and “reservoir property values” are defined as quantities representing physical attributes of rocks containing reservoir fluids. The term “reservoir properties” as used in this application includes both measurable and descriptive attributes.

As used herein, “geologic model” is a computer-based representation of a subsurface earth volume, such as a hydrocarbon reservoir or a depositional basin. Geologic models may take on many different forms. Depending on the context, descriptive or static geologic models built for petroleum applications can be in the form of a 3-D array of cells, to which reservoir properties are assigned. Many geologic models are constrained by stratigraphic or structural surfaces (for example, flooding surfaces, sequence interfaces, fluid contacts, faults) and boundaries (for example, facies changes). These surfaces and boundaries define regions within the model that possibly have different reservoir properties.

As used herein, “reservoir simulation model”, or “reservoir model” or “simulation model” refer to a mathematical representation of a hydrocarbon reservoir, and the fluids, wells and facilities associated with it. A reservoir simulation model may be considered to be a special case of a geologic model. Simulation models are used to conduct numerical experiments regarding future performance of the hydrocarbon reservoir to determine the most profitable operating strategy. An engineer managing a hydrocarbon reservoir may create many different simulation models, possibly with varying degrees of complexity, to quantify the past performance of the reservoir and predict its future performance.

As used herein, “well” or “wellbore” includes cased, cased and cemented, or open-hole wellbores, and may be any type of well, including, but not limited to, a producing well, an exploratory well, and the like. Wellbores may be vertical, horizontal, any angle between vertical and horizontal, diverted or non-diverted, and combinations thereof, for example a vertical well with a non-vertical component.

As used herein, “hydrocarbon production” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

In the present techniques, stencil computations are utilized in simulations, which involve complex 2-D and/or 3-D computations. In particular, stencil computations are utilized to perform finite difference simulations, finite volume simulations and/or finite element simulations using structured or semi-structured grids. With multiple processing devices (e.g., central processing units, graphical processing units (GPUs) and/or co-processing units), the problem being solved may be distributed over the different processing devices to lessen the processing time. The distribution of the problem includes decomposing a grid into multiple sub-grids, which may each be associated with a different processing device. Each sub-grid may involve some of the data owned by its adjacent sub-grids to perform the stencil computations (e.g., data owned refers to data stored, controlled and/or allocated to another processing device). The data received from other sub-grids are referred to as halos and the halos are not treated as data owned by the processing device (e.g., controlled by the processing device) on the receiving sub-grid.

The present techniques may be utilized for simulating the processing of measurement data, such as seismic data, controlled source electromagnetic, gravity and other measurement data types. The present techniques may be used in simulating wave propagation through subsurface media, which may be referred to as geologic simulations. As an example, the simulation may involve full wavefield inversion (FWI) and/or reverse time migration (RTM), which is a computer-implemented geophysical method that is used to invert for subsurface properties, such as velocity or acoustic impedance. The FWI algorithm can be described as follows: using a starting subsurface physical property model, synthetic seismic data are generated, i.e. modeled or simulated, by solving the wave equation using a numerical scheme (e.g., finite-difference, finite-element etc.). The term velocity model or physical property model as used herein refers to an array of numbers, typically a 3-D array, where each number, which may be called a model parameter, is a value of velocity or another physical property in a cell, where a subsurface region has been conceptually divided into discrete cells for computational purposes. The synthetic seismic data are compared with the field seismic data and using the difference between the two, an error or objective function is calculated. Using the objective function, a modified subsurface model is generated which is used to simulate a new set of synthetic seismic data. This new set of synthetic seismic data is compared with the field data to generate a new objective function. This process is repeated until the objective function is satisfactorily minimized and the final subsurface model is generated. A global or local optimization method is used to minimize the objective function and to update the subsurface model.

In addition, these simulations are utilized to determine the behavior of hydrocarbon-bearing reservoirs from the performance of a model of that reservoir. The objective of reservoir simulation is to understand the complex chemical, physical and fluid flow processes occurring in the reservoir to predict future behavior of the reservoir to maximize hydrocarbon recovery. Reservoir simulation often refers to the hydrodynamics of flow within a reservoir, but in a larger sense reservoir simulation can also refer to the total petroleum system which includes the reservoir, injection wells, production wells, surface flow lines, and/or surface processing facilities.

Hydrocarbon simulations may include numerically solving equations describing a physical phenomenon, such as geologic simulations and/or reservoir simulations. Such equations may include ordinary differential equations and partial differential equations. To solve such equations, the physical system to be modeled is divided into smaller cells or voxels and the variables continuously changing in each cell are represented by sets of equations, which may represent the fundamental principles of conservation of mass, energy, and/or momentum within each smaller cells or voxels and of movement of mass, energy, and/or momentum between cells or voxels. The simulation may include discrete intervals of time (e.g., time steps), which are associated with the changing conditions within the model as a function of time.

Further, the present techniques may be used for other applications of simulating physical systems by finite difference method (FDM); finite volume method (FVM); and/or finite element method (FEM). The physical systems may include aerospace modeling, medical modeling, and/or other modeling of physical systems.

Because each of the iterations in a simulation involves computing time, an incentive to use a method that lessens the computing time is present. The present techniques provide various enhancements that may be utilized to lessen computing time for simulations of a physical system. For example, the present techniques utilize the stencil parameters explicitly along with the local problem size to allocate memory for a processing device for data (e.g., one or more variables and/or one or more constants) utilized in the simulation. The stencil parameters are utilized to organize the data (e.g., one or more variables and/or one or more constants) into a 1-D array from a 2-D or 3-D volume. In this manner, the data from the 2-D or 3-D volume is divided into macroblocks that are stored in the 1-D array in an enhanced configuration. As a result, the processing device may perform the simulation with less overhead operations (e.g., halo operations).

According to aspects of the disclosed methodologies and techniques, the present techniques use 2-D and/or 3-D domain decomposition and store data to lessen halo injection operations in each of the directions and the halo extraction operations in the slow-varying directions. Further, while conventional approaches may re-order data to address locality as an approach to reduce the cache and TLB misses, these methods do not combine macro-block decomposition to reduce halo extraction and/or halo injection overhead with the data re-ordering to enhance locality. Moreover, many of the conventional approaches that use data re-ordering typically involve storing an additional look-up table to store the map for the re-ordering. In contrast, the present techniques do not use additional look-up tables as the mapping is built into the standard 3-D array data structure that is used for such stencil computations.

The present techniques provide various mechanisms to address deficiencies in conventional techniques. For example, the present techniques provides a specific configuration that lessens halo extraction and/or injection operations; enhances memory alignment for single instruction multiple data (SIMD) and lessens false sharing; provides data re-ordering to increase locality; and reduces data transfer between a host (e.g., central processing unit (CPU)) and a device (e.g., graphical processing unit, co-processor, and/or other processing devices associated the host). In particular, the present techniques involve a macro-block layout that is utilized to lessen halo extractions and/or injection operations. In this configuration, the interior portion of the volume is stored on the memory of the offloading processing device (e.g., GPU and/or co-processor). Also, the present techniques provide data re-ordering without exposing the mapping in the kernels.

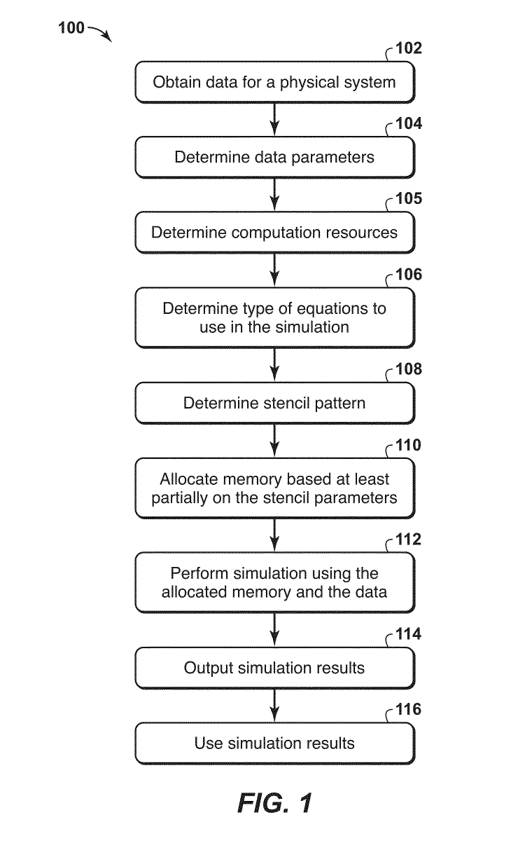

Beneficially, the present techniques provides wide scope for kernels in complex processing operations, such as reverse time migration (RTM) and full wavefield inversion (FWI) processing operations. Also, the present techniques provide enhanced scalability by eliminating numerous halo extraction and/or halo injection operations. Also, the present techniques provides enhanced data locality, which lessens cache and TLB misses. In addition, the present techniques provide enhancements to offload modeling, which lessens storage requirements on the memory controlled by a processing device, lessens data transfer between a host and an associated processing device; utilizes the host and the associated processing device concurrently or simultaneously for computations; and provides processing device independent of communication (e.g., communication between two processing devices). Also, the present techniques provide a flexible data layout (e.g., data-block) that is stencil (e.g., access pattern) aware and hardware aware. Various aspects of the present techniques are described further in FIGS. 1 to 7.

FIG. 1 is a flow diagram 100 of a method for configuring data blocks in accordance with an exemplary embodiment of the present techniques. In this flow diagram 100, various steps are performed to determine the memory allocation for a simulation of a physical system. The simulation may include parallel computing with multiple processing devices (e.g., processing units or processors) to reduce processing run time. The physical system may include modeling a subsurface formation (e.g., reservoir simulation or geologic simulation), modeling an aerospace system, modeling a medical system and/or the like. In particular, the present techniques provide enhancements through memory allocations and lessening of halo operations that are performed in a manner to enhance operation of the simulation on the processing devices.

At block 102, data is obtained for a physical system. For example, the data may include reservoir data, which is utilized in a reservoir simulation. The reservoir data may include properties, parameters and other data used for simulating transport of mass, energy, and momentum through a reservoir model. The reservoir data may include fluid properties, number and locations of wells, subsurface structures, model parameters, injection and production rates, reservoir pressure, history data, objective functions, genetic algorithms, flow equations, optimization algorithms and the like.

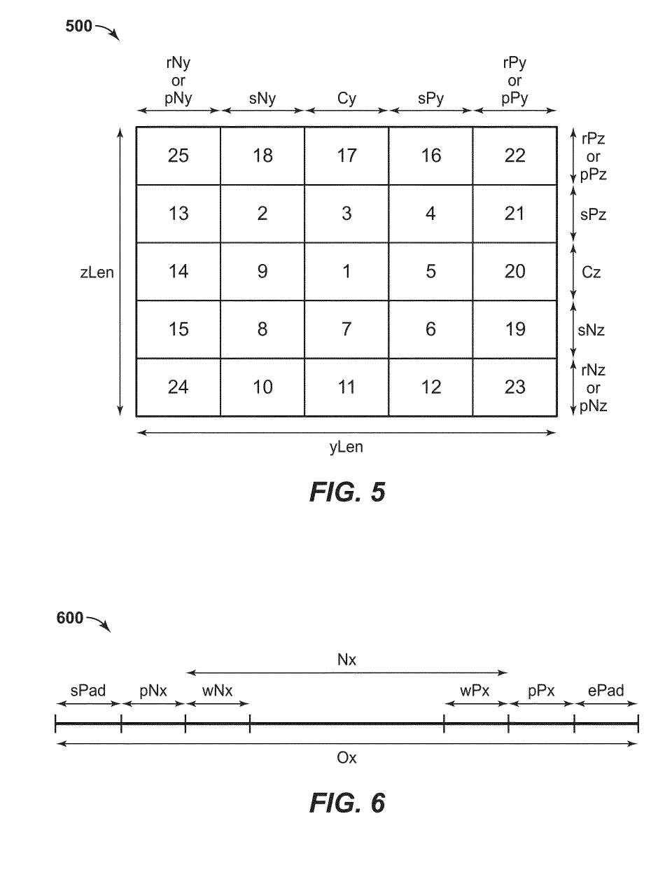

At block 104, various data parameters are determined. The data parameters may include global problem size. At block 105, the computational resources are determined. The determination of the computation resources may include determining the number of processing devices (e.g., central processing units, graphical processing units (GPUs) and/or co-processing units). At block 106, the type of equations to use for the simulation is determined. The selection of the equations may include the type of model to use in the simulation (e.g., elastic or acoustic, isotropic or anisotropic, etc.) and order of accuracy. The types of equations provide the stencil parameters. The stencil parameters may include the number of halos to be exchanged with adjacent processing devices (e.g., sent and/or received). For example, the stencil parameters may include widths of the halo layer received from the adjacent sub-grids (e.g., rNx, rNy, rNz, rPx, rPy and rPz, as noted below in FIGS. 5 and 6); widths of the layer within the writable region that is sent to adjacent sub-grids (e.g., sNx, sNy, sNz, sPx, sPy and sPz, as noted below in FIGS. 5 and 6); widths of the layer of owned data surrounding a writable region (e.g., pNx, pNy, pNz, pPx, pPy and pPz, as noted below in FIGS. 5 and 6); and widths of the dependent region (wNx, wNy wNz, wPx, wPy and wPz, as noted below in FIGS. 5 and 6). Then, at block 108, a stencil pattern is determined from the determined type of equations.

Following determining the stencil parameters, the memory is allocated at least partially based on the stencil parameters, as shown in block 110. The stencil parameters are utilized with local problem size to determine the grouping of macroblocks (e.g., the configuration of macroblocks). As an example, FIG. 4 describes an exemplary decomposition of memory into a group of macroblocks that are generated based on the present techniques.

Then, at block 112, a simulation is performed based on the memory allocation and the data. For example, a reservoir simulation includes conducting numerical experiments regarding future performance of the hydrocarbon reservoir to determine the optimal operating strategy (e.g., for optimal profitability or optimal hydrocarbon recovery). As noted above, a simulation may include performing calculations for various time-steps or time units. As another example, the simulation may include a geologic simulation of wave equations for subsurface region. This simulation may include modeling the subsurface in a manner to depict subsurface structures based on a comparison with measured data.

Then, the simulation results are output, as shown in block 114. Outputting the simulation results may include storing the simulation results in memory and/or providing a visual display of the simulation results. Based on the outputted simulation results, the simulation results may be utilized to enhance the operation or development of the physical system, as shown in block 116. For example, the simulation results may be used for hydrocarbon exploration, development and/or production operations. The exploration, development and/or production operations may utilize the simulation results to analyze the subsurface model to determine the structures or locations of hydrocarbons, which may be used to target further explore and develop of the hydrocarbons. The exploration, development and/or production operations, which may be referred to as hydrocarbon operations, may then be used to produce fluids, such as hydrocarbons from the subsurface accumulations. Producing hydrocarbon may include operations, such as modeling the location to drill a well, directing acquisition of data for placement of a well, drilling a well, building surface facilities to produce the hydrocarbons, along with other operations conducted in and/or associated with the well after the well is completed. Accordingly, producing hydrocarbons may include hydrocarbon extraction, along with injection of gas or liquid for increasing drive pressure, mobilizing the hydrocarbon or treating by, for example chemicals or hydraulic fracturing the wellbore to promote increased flow, well servicing, well logging, and other well and wellbore treatments.

As an example, Equations 1 and 2 together form a system of time dependent partial differential equations in two variables, u=u(x; y; z; t) and v=v(x; y; z; t) that represent a mathematical model of some physical system. The terms, α=α(x; y; z), β=β(x; y; z), γ=γ(x; y; z) and δ=δ(x; y; z), are spatially varying constants. For example, the constants may represent the material properties for the physical system being modelled. In these equations (e.g., equations (e1), (e2) and (e3)), t is time and x, y and z are spatial co-ordinates. ∇² is a second order differential operator known as the Laplace operator and is defined in third equation (e3) for any variable f. The equations (e1), (e2) and (e3) are as follows:

$$\begin{matrix}\frac{\partial u}{\partial t} = {α▽}^{2} u + {β▽}^{2} v & ( e1 ) \\ \frac{\partial v}{\partial t} = {γ▽}^{2} u + {δ▽}^{2} v & ( e2 ) \\ {▽}^{2} f = \frac{{\partial }^{2} f}{\partial {x}^{2}} + \frac{{\partial }^{2} f}{\partial {y}^{2}} + \frac{{\partial }^{2} f}{\partial {z}^{2}} & ( e3 )\end{matrix}$$

To solve such equations on a computer (e.g., with a processing device), the equations have to be discretized using a method, such as finite difference method, finite volume method or finite element method. For example, a finite difference approximations (e.g., in equations (e4), (e5) and (e6)), may be used. In these equations, Here, Δt is the time-step and Δx, Δy and Δz are the grid spacings in x, y and z dimensions, respectfully. The equations (e4), (e5) and (e6) are as follows:

$$\begin{matrix}\frac{\partial u}{\partial t} \approx \frac{u ( x , y , z , t + Δ t ) - u ( x , y , z , t - Δ t )}{2 Δ t} & ( e4 ) \\ \frac{{\partial }^{2} u}{\partial {x}^{2}} \approx \frac{u ( x + Δ x , y , z , t ) - 2 u ( x , y , z , t ) + u ( x - Δ x , y , z , t )}{{( Δ x )}^{2}} & ( e5 ) \\ \frac{{\partial }^{2} v}{\partial {y}^{2}} \approx \frac{\begin{matrix}- v ( x , y + 2 Δ y , z , t ) + 16 v ( x , y + Δ y , z , t ) - \\ 30 v ( x , y , z , t ) + 16 v ( x , y - Δ y , z , t ) - v ( x , y - 2 Δ y , z , t )\end{matrix}}{12 {( Δ y )}^{2}} & ( e6 )\end{matrix}$$

The stencil parameters can then be determined from these discretized equations. For example, from the equation (e5), sNx=rNx=sPx=rPx=1 and from the equation (e6), sNy=rNy=sP y=rPy=2.

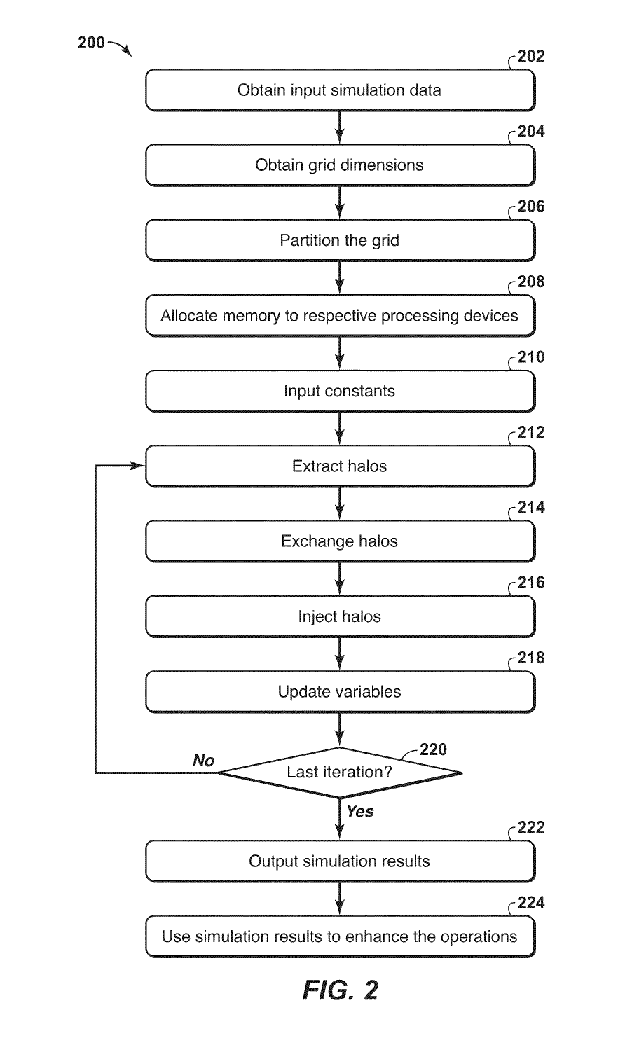

FIG. 2 is a flow diagram 200 of a method for simulating using stencil computations in accordance with an exemplary embodiment of the present techniques. In this flow diagram 200, various steps are performed to enhance the simulation of a physical system. In this diagram 200, the pre-simulation operations are described in blocks 202 to 210, which are followed by the simulation in blocks 212 to 220 and the post simulation operations in blocks 222 and 224. In particular, the present techniques provide enhancements through memory allocations that are performed in a manner to enhance operation of the simulation (e.g., lessening the halo operations performed during the simulation).

At block 202, input simulation data is obtained for a physical system. The input simulation data may include data for the physical, data parameters, types of equations, and computation resources, as noted above in blocks 102, 104, 106, 108. At block 204, grid dimensions are obtained. The grid dimensions may be based on the input simulation data, such as the global problem size. At block 206, the grid is partitioned. The partitioning of the grid may include computational resources and the global problem size to determine the local problem size (e.g., Nx, Ny and Nz). The local problem size is used to identify data associated with a single processing device and is referred to as a sub-grid. Then, at block 208, memory may be allocated to the respective processing devices. The respective processing devices manage and control the portion of the data within that memory that is allocated for the local problem assigned to that processing device. The memory allocation relies upon the partitioned grid (e.g., local problem size or portion of the problem that is provided to the specific processing device) and the stencil parameters. The memory allocation may rely upon additional hardware parameters, such as cache and number of cores, for example. Following the allocation of memory, constants may be inputted, as shown in block 210. The constants are data values that do not change in the time-steps of the simulation.

Then, the simulation is performed using the memory allocation and the data, which represented by blocks 212 to 220, and may be a simulation or performed in a manner similar to block 112 of FIG. 1. In block 212, halos are extracted. The halo extraction may include transferring a portion of the data from one sub-grid (e.g., memory allocated to a processing device) and transferring the data to a buffer. In block 214, the halos are exchanged. The halos exchange may include transferring the buffers from the memory of one processing device to a buffer for a second processing device. In block 216, halos are injected. The halos injections may include transferring the data from the buffer to memory locations associated with the sub-grid of the processing device. In block 218, the variables are updated. The updating of the variables may include performing the computations for the cells in the sub-grid. The results of the computations are used to update the variables.

Then, a determination is made whether this is the last iteration, as shown in block 220. This determination may include performing a set number of iterations or identifying if stopping criteria or a threshold has been reached. The identification of stopping criteria or a threshold may include calculating one or more genetic algorithms, objective function or other optimization algorithm and comparing the result of the calculation to a threshold to determine if additional iterations are needed. If this is not the last iteration, the process proceeds to block 212 and continues through the blocks 212, 214, 216, and 218. However, if this is the last iteration, the simulation results are output, as shown in block 222. Outputting the simulation results may include storing the simulation results in memory and/or providing a visual display of the simulation results. As may be appreciated, the ordering of the blocks for the simulation may be adjusted. For example, block 218 may be performed before blocks 212, 214 and 216.

The simulation results may be used to enhance operations associated with the physical system, as shown in block 224. Based on the outputted simulation results, the simulation results may be utilized to enhance the operation or development of the physical system. For example, the simulation results may be used for hydrocarbon exploration, development and/or production operations, as shown in block 224. Similar to block 114 of FIG. 1, the simulation results may be used to enhance location and production of hydrocarbons.

Beneficially, the present techniques lessen the number of halo operations being performed by the processing devices by utilizing the stencil parameters in the memory allocation (e.g., lessening halo operations in blocks 212 and 216). Further, the offloading model operations are enhanced by lessening the data being transferred between the memory associated with different processing devices (e.g., operations in block 214). Also, the data locality enhances the operational efficiency of the processing device in the computations performed to updating variables (e.g., operations in block 218). As a result, the present techniques enhance the data transfers in the simulation.

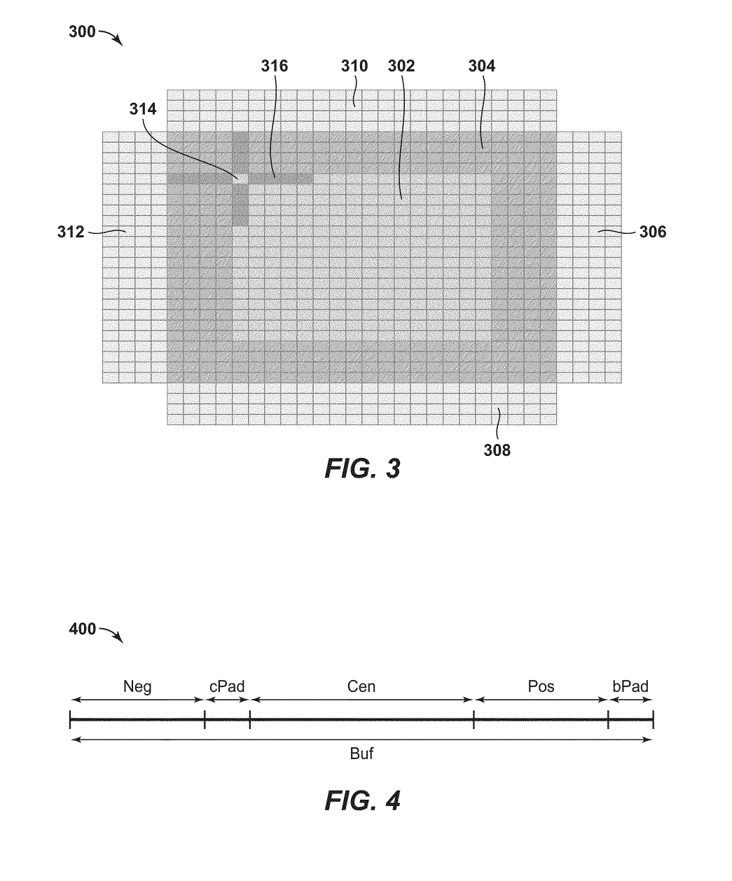

FIG. 3 is an exemplary diagram 300 of sub-grid and associated halos received from other sub-grids for a processing device. In this diagram 300, cells 302 and cells 304 are the portions of the sub-grid for a processing device. The cells 302 (e.g., memory locations within the center of the sub-grid and within the cells 304) do not involve accessing data from other processors for the computations associated with these cells, while the cells 304 involve data exchanges from memory associated with other processing devices, which is shown as cells 306, 308, 310 and 312. The cells 304 are the halos sent to memory associated with other processing devices, while the cells 306, 308, 310 and 312 are the halos received memory associated with other processing devices. For example, the extraction of halos involves transferring of data from the cells 304 to the respective buffers, while the injection of halos involves the transferring of data to cells 306, 308, 310 and 312 from buffers. As a specific example, the processing of cells 314 involves data from the cells 316, which are the four cells to the right of cell 314, four cells to the left of cell 314, four cell to the above of cell 314, and four cells to the below of cell 314. This example does not involve any halo operations, as the cells are associated with the processing device performing the computation. Various variations of the number of adjacent cells may be used for calculations and the corner cells (not shown) may also be included in other configurations.

In the computations, at least a portion of the data (e.g., one or more variables and constants) are defined at each cell of the sub-grid and the values of the variables at any given cell are updated using the values of the remaining variables and constants in a small neighborhood of cells around the given cell. For example, the memory locations 316 may be used to compute a variable in memory location 314. The data for any given sub-grid are typically stored in contiguous memory locations using one-dimension (1-D) arrays. The halos may be stored together with the data owned by the processor in the same 1-D array. The cells in a 3-D sub-grid, represented by the triad, (ix, iy, iz), containing its coordinates in the sub-grid, is mapped to an unique index, i, in the corresponding 1-D array, as shown below in equation (e7):

(ix,iy,iz)→i=(((iz*My)+iy)*Mx)+ix (e7)

where Mx and My are the dimensions of the sub-grid in the X and Y directions.

According to this mapping, X is the fastest-varying dimension and Z is the slowest-varying dimension. This convention, which is referred to as a lexicographic data layout, is utilized for exemplary purposes, as different conventions may be utilized. Also, while this is described for 3-D grids, but the present techniques may also be utilized for 2-D grids by simply setting one of the slow-varying dimensions (Y or Z) to 1.

The present techniques provide enhancements to the memory location storage, which is referred to as a data-block. The data-block is implemented to store the data in a manner that lessens issues with the lexicographic data layout, such as the numerous extraction and injection of halo operations.

The data exchange between two sub-grids is typically more efficient if the data that is being sent or received are stored contiguously in memory. The conventional lexicographic data layout does not sort memory in contiguous locations in memory. Hence, the data is first extracted and packed contiguously into a temporary buffer prior to sending the data and the received data is unpacked and injected back into the corresponding memory locations (e.g., cells).

Further, in the lexicographic data layout, the data corresponding to neighboring cells may be placed far apart in memory. In particular, the stride width for the slowest-varying dimension can be quite large. This typically results in data locality problems, such as cache and TLB misses that stall the stencil computations.

Also, in an offload programming model, one or more of the computations are performed on specialized hardware, such as graphical processing units (GPUs) and/or co-processors. In this configuration, data is stored both in device's memory (e.g., a subordinate processing device to the host) as well as in the host's memory and data is exchanged between the memory of the host and the device when needed. Further, the entire sub-grid may be stored on the device memory and all the cells are processed on the device. It is more efficient to store the interior cells (and their halos) of the sub-domain on the device's memory and store the remaining cells on the host's memory and utilize both the host's memory and device's memory for the computations. This lessens the storage requirements on the device's memory and also lessens the amount of data transferred between the host's memory and device's memory. However, conventional lexicographic data layout does not provide this functionality.

The present techniques allocate memory at least partially based on the partitioned grid (e.g., local problem size or portion of the problem that is provided to the specific processing device) and the stencil parameters. This allocation enhances the simulation operations by lessening the halo operations performed during the simulation.

As an example, each sub-grid is responsible for updating the values of one or more variables in some region (e.g., Neg, Cen and Pos) contained within the memory associated with the sub-grid, which is referred to as a writable region. Neg, Cen and Pos are each sub-divided into macro-blocks. Neg is the halos received from processor in negative X direction, Pos is the halos received from processor in positive X direction, and Cen is the part of X dimension that is owned by the processing device. The writable region is the portion of the memory that the processing device may modify (Neg and Pos are not writable, but a portion of Cen is writable to memory).

For example, if local problem dimensions (e.g., Nx, Ny and Nz) are the dimensions of the writable region in the X, Y and Z directions, respectively, then rNx, rNy, rNz, rPx, rPy and rPz are the widths of the halo layer received from the adjacent sub-grids in the Negative-X, Negative-Y, Negative-Z, Positive-X, Positive-Y and Positive-Z directions, respectively. Also, sNx, sNy, sNz, sPx, sPy and sPz are the widths of the layer within the writable region that is sent to adjacent sub-grids in the Negative-X, Negative-Y, Negative-Z, Positive-X, Positive-Y and Positive-Z directions, respectively. For some stencil computations, a layer of owned data surrounding the writable region may be utilized. The pNx, pNy, pNz, pPx, pPy and pPz may be the widths of this layer in the Negative-X, Negative-Y, Negative-Z, Positive-X, Positive-Y and Positive-Z directions, respectively. The values in the interior of the writable region can be updated before receiving the halo layer, which is an independent region and the remaining portion of the writable region is referred to as the dependent region. If wNx, wNy, wNz, wPx, wPy and wPz are the widths of the dependent region in the Negative-X, Negative-Y, Negative-Z, Positive-X, Positive-Y and Positive-Z directions, respectively; then these are the maximum (across variables) widths of the stencils in the respective directions, but wNx and wPx may be greater than these values in certain situations to satisfy additional memory alignment requirements.

The parameters described above may be different for different sub-grids and different for different variables or constants on the same sub-grid, but the parameters should satisfy the following certain consistency constraints. The consistency constraints may include each of the data on the same sub-grid having to use the same dimensions for the writable, independent and dependent regions. Also, the consistency constraints may include that if two sub-grids share an X face, then the two sub-grids must have the same Ny and Nz, which may be similar for the other faces. Further, the consistency constraints may include that if two sub-grids share an X-Y edge, then the two sub-grids have the same Nz, which may be similar for the other edges. In addition, the consistency constraints may include that for any variable, rNx on a sub-grid should match sPx on the sub-grid that is sending the corresponding part of the halo, which may be similar, for the pairs rPx and sNx, rNy and sPy, rPy and sNy, rNz and sPz, and rPz and sNz. Also, the consistency constraints may include that for any variable or constant on any sub-grid, at least one of pNx and rNx is zero, which is similar for the pairs pNy and rNy, pNz and rNz, pPx and rPx, pPy and rPy and pPz and rPz.

For each sub-grid and each variable and/or constant defined on that sub-grid, a 1-D array may be used, which is referred to as buffer Buf, to store the corresponding values in memory. The buffer Buf is subdivided into different regions as shown in FIG. 4. FIG. 4 is a layout diagram 400 of a 1D array. In this diagram 400, Neg and Pos are used to store the halos received from the adjacent sub-grids in the negative and positive X directions. Cen is used to store the values at the remaining cells in the sub-grid. The alignment padding, cPad and bPad, are padding that are inserted for proper memory alignment. The number of elements in Neg and Pos are (rNx*yLen*zLen) and (rPx*yLen*zLen), respectively; where, yLen is equal to (Ny+pNy+rNy+pPy+rPy) and zLen is equal to (Nz+pNz+rNz+pPz+rPz).

As may be appreciated, various different embodiments may be utilized to store the data (e.g., one or more variables and/or one or more constants) into a 1-D array from a 2-D or 3-D volume. For example, each variable or constant may be individually stored into a 1-D array. Alternatively, various combinations of variables and/or constants may be stored into a single 1-D array. Further still, in other configurations, the Cen, Neg and Pos regions may be stored as individual 1-D arrays.

FIG. 5 is a layout diagram of an exemplary group of macro-blocks that are decomposed from one of the three regions of Neg, Cen and Pos of FIG. 4 in accordance with an exemplary embodiment of the present techniques. In this macro-block 500, each of the three regions, Neg, Cen and Pos, are sub-divided into macro-blocks. In this diagram 500, the sub-grid is divided into twenty-five macro-blocks in YZ plane. Macroblock 1 is located in the interior (e.g., cells 302 of FIG. 3); macroblocks 2 to 9 are the sent to other macroblock (e.g., cells 304 of FIG. 3); macroblocks 10 to 25 are the received data from other processing devices (e.g., cells 306, 308, 310 and 312 of FIG. 3). For the macroblocks of Cen, the macroblocks 1 to 9 are the writable region, while the macroblocks 10 to 25 are not writable. In addition, the macroblocks of Neg and Pos are not writable.

In this diagram 500, Cy is equal to (Ny−sNy−sPy) and Cz is equal to (Nz−sNz−sPz). The i-th portion of the memory assigned to each region (e.g., Neg, Cen and Pos) is used to store the elements in its i-th macro-block. The first macro-block in each of Neg, Cen and Pos is sub-divided into a number of thread-blocks in either the Y or Z or both Y and Z dimensions. This thread-block decomposition depends on Ny and Nz and the number of threads used in the computation. The thread-block decomposition may vary on different sub-grids, but should be consistent across each of the data on the same sub-grid and also between adjacent sub-grids that share an X face. The i-th portion of the memory assigned to the first macro-block is used to store the elements in its i-th thread-block. Each thread-block and each of the other macro-blocks are further sub-divided into a 2-D (Y and Z dimensions) grid of micro-blocks. The Y and Z dimensions of each micro-block may be restricted to being less than a certain block size, such as Y_BLOCK_SIZE and/or Z_BLOCK_SIZE, respectively. For these block sizes, Y_BLOCK_SIZE and Z_BLOCK_SIZE are constants chosen depending on the stencils used and the hardware parameters, such as cache sizes. The micro-blocks within a macro-block or thread-block are ordered using a lexicographic order or a space-filling curve based order such as Morton order or Hilbert order. The i-th portion of the memory assigned to a macro-block or thread-block is used to store the elements in its i-th micro-block. Each micro-block consists of a 3-D grid of cells; these cells are arranged according to a lexicographic order and stored in memory in this order.

As may be appreciated, the exemplary macroblock is one realization of the Data-Block layout. Other realizations may be obtained through permutations of the relative positions of the different regions shown in FIG. 4 below. Similarly, the relative positions of the macro-blocks 1, 2, 10, 22, 23, 24 and 25 in memory can be permuted to obtain other equivalent realizations. For example, a clock-wise or counter-clock-wise arrangement of the macro-blocks 2 through 9 may provide other equivalent realization (e.g., the writable region of Cen). However, the macro-blocks 10 through 21 may have to be re-arranged. As another embodiment, the Neg, Cen and Pos regions may be allocated separately instead of sub-dividing from buffer Buf. Further still, the first macro-block of the Cen region may be allocated separately instead of sub-dividing from Buf, which may be utilized for the offload model.

As X is the fastest dimension for processing, this direction is treated differently from Y and Z. As a further example of the dimensions in the 1-D array, FIG. 6 is a layout diagram of the X dimension in the Cen region from the layout diagram of FIG. 4. The X dimension of Cen may be subdivided, as shown in FIG. 6. In this diagram 600, the X dimension of Cen is sub-divided into Nx (writable size); wNx and wPx (dependent size (aligned maximum stencil width)) and pNx and pPx (offsets for read-only variables). The alignment padding is sPad and ePad, which are padding inserted at the start and end of each line along the X dimension for proper memory alignment. The number of elements in Cen is (Ox*yLen*zLen); where, Ox is equal to (sPad+pNx+Nx+pPx+ePad).

The simulation may be performed on a computer system. The computer system may be a high-performance computing system that includes multiple processors, graphical processing units or co-processing units. For example, computer system may include a cluster of processors, memory and other components that interact with each other to process data.

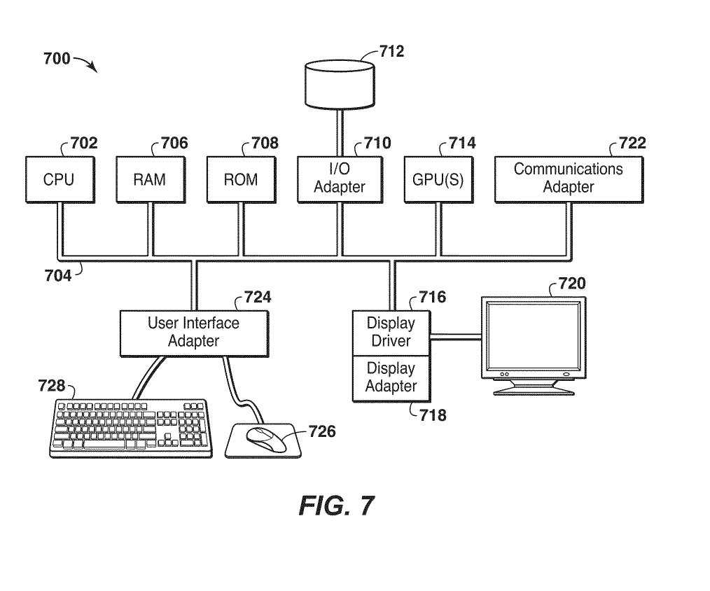

As an example, FIG. 7 is a block diagram of a computer system 700 in accordance with an exemplary embodiment of the present techniques. At least one central processing unit (CPU) 702 is coupled to system bus 704. The CPU 702 may be any general-purpose CPU, although other types of architectures of CPU 702 (or other components of exemplary system 700) may be used as long as CPU 702 (and other components of system 700) supports the inventive operations as described herein. The CPU 702 may execute the various logical instructions according to various exemplary embodiments. For example, the CPU 702 may execute machine-level instructions for performing processing according to the operational flow described above.

The computer system 700 may also include computer components such as a random access memory (RAM) 706, which may be SRAM, DRAM, SDRAM, or the like. The computer system 700 may also include non-transitory, computer-readable read-only memory (ROM) 708, which may be PROM, EPROM, EEPROM, or the like. RAM 706 and ROM 708 hold user and system data and programs, as is known in the art. The computer system 700 may also include an input/output (I/O) adapter 710, a communications adapter 722, a user interface adapter 724, and a display adapter 718. The I/O adapter 710, the user interface adapter 724, and/or communications adapter 722 may, in certain embodiments, enable a user to interact with computer system 700 in order to input information.

The I/O adapter 710 preferably connects a storage device(s) 712, such as one or more of hard drive, compact disc (CD) drive, floppy disk drive, tape drive, etc. to computer system 700. The storage device(s) may be used when RAM 706 is insufficient for the memory requirements associated with storing data for operations of embodiments of the present techniques. The data storage of the computer system 700 may be used for storing information and/or other data used or generated as disclosed herein. The communications adapter 722 may couple the computer system 700 to a network (not shown), which may enable information to be input to and/or output from system 700 via the network (for example, the Internet or other wide-area network, a local-area network, a wireless network, any combination of the foregoing). User interface adapter 724 couples user input devices, such as a keyboard 728, a pointing device 726, and the like, to computer system 700. The display adapter 718 is driven by the CPU 702 to control, through a display driver 716, the display on a display device 720. Information and/or representations pertaining to a portion of a supply chain design or a shipping simulation, such as displaying data corresponding to a physical or financial property of interest, may thereby be displayed, according to certain exemplary embodiments.

The architecture of system 700 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

In one more embodiments, a computer system for simulating a physical system with two or more processing devices is described. The computer system may include two or more processing devices; non-transitory, computer-readable memory in communication with at least one of the processing devices; and a set of instructions stored in non-transitory, computer-readable memory and accessible by the processor. The plurality of processing devices may include a central processing unit and one or more of a graphical processing unit and a co-processing unit. The set of instructions, when executed by the processor, are configured to: determine stencil parameters for data representing a physical system; allocate memory for at least one of the plurality of processing devices based at least partially on the stencil parameters, wherein the allocated memory is further divided into a plurality of macroblocks based on the stencil parameters; perform a simulation with the data and the plurality of processing devices, wherein the at least one of the plurality of processing devices relies upon the allocated memory to perform stencil computations for a portion of the data associated with the at least one of the plurality of processing devices; and output the simulation results. The stencil parameters may be determined or identified based on equations used in the simulation. Further, the memory allocation may lessen the halo operations as compared to a memory allocation performed independently of the stencil parameters.

In one or more other embodiments, other enhancements for the instructions may be utilized. For example, the set of instructions may be configured to exchange data from the memory allocated between two different processing devices of the plurality of processing devices to perform stencil computations. Also, the set of instructions are further configured to: obtain grid dimensions based on a global problem size for the physical system; decompose a grid into two or more sub-grids based on the plurality of processing devices; and wherein the allocated memory is based at least partially on a local problem size for the at least one of the plurality of processing devices. In addition, the set of instructions are further configured to: assign one of the two or more sub-grids to the at least one of the plurality of processing devices; divide the one of the two or more sub-grids into a plurality of regions; and divide the plurality of regions into the plurality of macroblocks. The set of instructions may be configured to store the plurality of macroblocks in a 1-D array in memory. The 1-D array may be associated with a single variable or constant; may be associated with one or two or more variables, two or more constants and a combination of at least one variable and one or more constant; and may be associated with one of the regions for a single variable or a single constant.

As further examples, computer system includes data associated with a subsurface formation. In particular, the simulation may model chemical, physical and fluid flow processes occurring in a subsurface formation to predict behavior of hydrocarbons within a subsurface formation. In an alternative example, the simulation may model wave propagation through a subsurface formation.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other.

What is claimed is:

1. A method for using a simulation of a physical system simulated with two or more processing devices comprising:
determining stencil parameters for data representing a physical system;
allocating memory for at least one of a plurality of processing devices based at least partially on the stencil parameters, wherein the allocated memory is further divided into a plurality of macroblocks based on the stencil parameters;
concurrently processing with the plurality of processing devices the data in a simulation of the physical system;
outputting the simulation results; and
performing one or more hydrocarbon management operations on the physical system based at least in part on the simulation results.

2. The method of claim 1, wherein concurrently processing comprises concurrently performing stencil computations with each of the plurality of processing devices, wherein each of the plurality of processing devices perform stencil computations for a portion of the data.

3. The method of claim 2, wherein the stencil computations comprise exchanging data from the memory allocated between two different processing devices of the plurality of processing devices.

4. The method of claim 1, further comprising:
obtaining grid dimensions based on a global problem size for the physical system;
decomposing a grid into two or more sub-grids based on the plurality of processing devices; and
wherein the allocating memory is based at least partially on a local problem size for the at least one of the plurality of processing devices.

5. The method of claim 1, wherein the allocating memory for the at least one of the plurality of processing devices further comprises:
assigning one of the two or more sub-grids to the at least one of the plurality of processing devices;
dividing the one of the two or more sub-grids into a plurality of regions; and
dividing the plurality of regions into the plurality of macroblocks.

6. The method of claim 1, wherein the determining stencil parameters for data representing the physical system is based on equations used in the simulation.

7. The method of claim 1, further comprising storing the plurality of macroblocks in a 1-D array in memory.

8. The method of claim 7, wherein the 1-D array is associated with a single variable or constant.

9. The method of claim 7, wherein the 1-D array is associated with one of two or more variables, two or more constants and a combination of at least one variable and one or more constant.

10. The method of claim 7, wherein the 1-D array is associated with one of the regions for a single variable or a single constant.

11. The method of claim 1, wherein the data is associated with a subsurface formation.

12. The method of claim 1, wherein performing operations on the physical system based on the simulation results comprises developing or refining an exploration, development or production strategy based on the simulation results.

13. The method of claim 1, wherein the plurality of processing devices comprise a central processing unit and one or more of a graphical processing unit and a co-processing unit.

14. The method of claim 1, wherein the memory allocation lessens the halo operations for the simulation as compared to a memory allocation performed independently of the stencil parameters.

15. The method of claim 1, wherein the concurrently processing is performed to model chemical, physical and fluid flow processes occurring in a subsurface formation to predict behavior of hydrocarbons within the subsurface formation.

16. The method of claim 1, wherein the concurrently processing is performed to simulate wave propagation through subsurface formation.

17. A computer system for simulating a physical system with two or more processing devices comprising:
a plurality of processing devices;
a non-transitory, computer-readable memory in communication with at least one of the plurality of processing devices; and
a set of instructions stored in the non-transitory, computer-readable memory and accessible by the processor, the set of instructions, when executed by the processor, are configured to:
determine stencil parameters for data representing a physical system;
allocate memory for at least one of the plurality of processing devices based at least partially on the stencil parameters, wherein the allocated memory is further divided into a plurality of macroblocks based on the stencil parameters;
perform a simulation with the data and the plurality of processing devices, wherein the at least one of the plurality of processing devices relies upon the allocated memory to perform stencil computations for a portion of the data associated with the at least one of the plurality of processing devices; and
output the simulation results.

18. The computer system of claim 17, wherein the performed stencil computations comprise exchanging data from the allocated memory between two different processing devices of the plurality of processing devices.

19. The computer system of claim 17, wherein the set of instructions are further configured to:
obtain grid dimensions based on a global problem size for the physical system;
decompose a grid into two or more sub-grids based on the plurality of processing devices; and
wherein the allocated memory is based at least partially on a local problem size for the at least one of the plurality of processing devices.

20. The computer system of claim 19, wherein the set of instructions are further configured to:
assign one of the two or more sub-grids to the at least one of the plurality of processing devices;
divide the one of the two or more sub-grids into a plurality of regions; and
divide the plurality of regions into the plurality of macroblocks.

21. The computer system of claim 20, wherein the set of instructions are further configured to store the plurality of macroblocks in a 1-D array in memory.

22. The computer system of claim 21, wherein the 1-D array is associated with a single variable or constant.

23. The computer system of claim 21, wherein the 1-D array is associated with one of two or more variables, two or more constants and a combination of at least one variable and one or more constant.

24. The computer system of claim 21, wherein the 1-D array is associated with one of the plurality of regions for a single variable or a single constant.

25. The computer system of claim 17, wherein the data is associated with a subsurface formation.

26. The computer system of claim 17, wherein the plurality of processing devices comprise a central processing unit and one or more of a graphical processing unit and a co-processing unit.

27. The computer system of claim 17, wherein the memory allocation lessens the halo operations for the simulation as compared to a memory allocation performed independently of the stencil parameters.

28. The computer system of claim 17, wherein the simulation models chemical, physical and fluid flow processes occurring in a subsurface formation to predict behavior of hydrocarbons within a subsurface formation.

29. The computer system of claim 17, wherein the simulation models wave propagation through a subsurface formation.

30. The computer system of claim 17, wherein the wherein the set of instructions are further configured to determine the stencil parameters based on equations used in the simulation.
